(19) United States
(12) Patent Application Publication
(10) Pub. No.: US 2016/0221282 A1
(43) Pub. Date: Aug. 4, 2016

(54) METHOD FOR PRODUCING A CASING OF A PLUG PART

(71) Applicant: NEUTRIK AG, Schaan (LI)

(72) Inventor: Martin Maikisch, Satteins (AT)

(73) Assignee: NEUTRIK AG, Schaan (LI)

(21) Appl. No.: 15/006,444

(22) Filed: Jan. 26, 2016

(30) Foreign Application Priority Data
Jan. 30, 2015 (DE) 102015101362.2

(51) Int. Cl. B29D 11/00; B29C 45/17; H01R 24/28; G02B 6/38; H01R 13/533; B29C 44/02; B29C 45/14

(52) U.S. Cl. CPC B29D 11/0075; B29C 44/02; B29C 45/1704; B29C 45/14; G02B 6/3865; H01R 13/533; H01R 24/28; B29K 2105/04

(57) ABSTRACT

Method for producing a casing (1) of a plug part (2) for an electrical and/or optical plug-in connection and/or a cable (3), wherein the casing (1) is produced via injection molding from a thermoplastic material (4) in an injection mold (5), wherein at least one outgassing propellant (6) and/or at least one gas are injected into the injection mold (5) in addition to the thermoplastic material (4), and gas cavities (7) are formed in the casing (1).

### INCORPORATION BY REFERENCE

The following documents are incorporated herein by reference as if fully set forth: German Patent Application DE102015101362.2, filed Jan. 30, 2015.

### BACKGROUND

The following invention relates to a method for producing a casing of a plug part for an electrical and/or optical plug-in connection and/or a cable, wherein the casing is produced by via injection molding from a thermoplastic material in an injection mold. Furthermore, the invention also relates to a casing of a plug part for an electrical and/or optical plug-in connection and/or a casing of a cable.

In the prior art, it is known to produce casings of the aforementioned type using injection molding methods. These casings can for example encase a cable to form an anti-kink grommet for the cable. It is also known to overmold casings onto main bodies of plug parts for electrical and/or optical plug-in connections to create a certain feel or design, or a desired electrical insulation, or shock or corrosion protection on the plug part.

### SUMMARY

It is an object of the invention to improve a generic method such that the casing can be produced more quickly and hence more easily via injection molding.

In a method of the aforementioned type, it is envisioned in this respect to inject at least one outgassing propellant and/or at least one gas into the injection mold in addition to the thermoplastic material, and to form gas cavities in the casing.

By adding the propellant to the thermoplastic material during injection molding, gas cavities are formed in the casing from the outgassing of the propellant. Alternately, gas can also be directly co-injected to form the gas cavities. This cools the casing more quickly so that the entire injection molding process up to the removal of the casing from the injection mold can be shortened in comparison to the prior art; consequently, the casing can be produced more quickly and hence more economically. Another positive effect of the invention from an economic perspective is that less thermoplastic material is consumed per casing in comparison to a conventional production method. The casing is hence lighter on the one hand and cheaper to produce on the other hand.

With the method according to the invention, it is possible to work with lower injection pressures as well as lower injection temperatures while injection molding due to the use of the propellant or gas. So-called low-pressure injection molding is possible. In preferred embodiments of the method according to the invention, the injection pressure lies between 5 bar and 40 bar. In methods according to the invention, preferred injection temperature ranges lie between 100° C. and 240° C. Both value ranges lie clearly below the injection pressures and injection temperatures required in the prior art. For the sake of completeness, it is noted that, apart from the measures cited specifically here, the injection molding process for producing the casing can otherwise be carried out as in the prior art. Since such injection molding methods are well known in a wide variety in the prior art, they will not be described again in detail here.

The lower injection pressures and injection temperatures are also economically advantageous since the employed injection molding machines can be constructed smaller and also consume less energy. In addition to the purely economic advantages, the invention also yields advantages in quality. Accordingly, through the addition of propellant and/or gas and the gas cavities formed thereby in the casing, the elasticity of the end product, i.e., the casing, can be very specifically adjusted within the desired range. The flexural fatigue strength of the produced end product is also improved in comparison to the prior art. Casings produced according to the invention hence last longer, even under great mechanical stress, and fail less quickly.

The thermoplastic material used according to the invention, or in other words thermoplastic, is in principle a plastic which can be deformed within a specific temperature range, and this process is reversible, so that the thermoplastic material can be changed from a solid into a liquid state during injection molding and then back into a solid aggregate state while being cooled. This is well known along with numerous thermoplastics or thermoplastic materials suitable for injection molding. In principle, highly diverse thermoplastic materials can be used in conjunction with the invention. It is particularly preferable to use thermoplastic elastomers or PVC in conjunction with the invention. Examples of suitable thermoplastic elastomers which can be cited are for example olefin-based thermoplastic elastomers, olefin-based cross-linked thermoplastic elastomers, urethane-based cross-linked thermoplastic elastomers, thermoplastic polyester elastomers, thermoplastic copolyesters or styrene block copolymers, as well as thermoplastic copolyamides.

As already mentioned above, the gas cavities in the casing can be generated in various ways. It is for example possible to co-inject an outgassing propellant into the injection mold, and the gas cavities are formed in the casing by the outgassing of the propellant. The propellant is advantageously a chemical propellant, i.e., a chemical substance from which gas splits off or is released when it decomposes. Preferably, the propellant, and in particular the chemical propellant, is activated thermally to trigger the outgassing process. A chemical activation of the propellant is, however, also possible in principle, for example by bringing at least two components together so that they trigger the outgassing process from chemical interactions. In particularly preferred variants, the propellant is activated thermally to trigger the outgassing process, preferably in the injection mold. The thermoplastic material and/or the propellant can for example be in the form of granules before the start of the injection molding process. Liquids with a correspondingly low evaporation temperature can also be used as the propellant. These can also be thermally activated, i.e., excited to evaporate and hence form gas. In alternative embodiments of the invention, it can also be provided that the thermoplastic material and the propellant are not mixed beforehand but rather injected simultaneously or sequentially into the injection mold. Instead of the propellant, it is also conceivable to directly inject at least one gas into the injection mold in addition to the thermoplastic material. Suitable gases for this are for example nitrogen (N₂) or carbon dioxide (CO₂). For the sake of completeness, it is noted that the thermoplastic material, the propellant and also the gases can be a single substance or material as well as a mixture of a plurality of materials, propellants or gases.

Suitable propellants and gases are well known in the prior art. Examples of suitable granular propellants are available on the market under the trade name of Hydrocerol. Gasoline or water can for example be used as a liquid propellant. The propellants can be formed of organic as well as inorganic compounds.

Expediently, the gas cavities are created in the form of enclosed gas bubbles or pores. This could hence also be termed a closed porosity. The formation of an open porosity, i.e., gas bubbles or pores connected to each other, is also conceivable, however. The added amount of propellant and/or gas or propellant gas is preferably adjusted so that the porosity of the end product, i.e., the casing, caused by the gas cavities lies within a range between 5% and 40%. In other words, the gas cavities then have a percent by volume of preferably 5 to 40% of the end product or the casing. This percent by volume of the gas cavities or this porosity can however also reach values up to 60% or even up to 80%. The gas cavities are arranged in the finished casing in a matrix consisting of the thermoplastic material. In other words, the gas cavities form a porosity in the thermoplastic material of the finished casing. This could also be termed a foaming of the thermoplastic material.

Preferred embodiments of the invention envision co-injecting the propellant into the injection mold at a portion of 0.5% to 5%, preferably 1.5% to 2.5%, with reference to the state before outgassing, of the overall mass of the thermoplastic material and the propellant.

In the method according to the invention, the casing can be overmolded onto a main body of the plug part and/or onto the cable. In this variant this could also be termed encapsulation of the main body and/or the cable by injection molding. For this purpose, the main body and/or the cable is introduced before the injection process into the injection mold, as is well-known. When the injection mold is closed, the injected thermoplastic material is then directly overmolded onto the main body and/or the cable. An alternative of the method according to the invention can also consist in first producing the casing in the injection mold via injection molding and then attaching it to or on the main body of the plug part and/or the cable.

In addition to the method, the casing of a plug part for an electrical and/or optical plug-in connection and/or a cable is the subject of the invention, wherein the casing has thermoplastic material, and gas cavities are present in the thermoplastic material in the casing. Such casings can be produced using the method according to the invention. As already mentioned above, the porosity generated in the casing by the gas cavities expediently lies within a range between 5% and 40%. The gas cavities are preferably formed as a plurality of gas bubbles or pores distributed throughout the casing. Expediently, the gas inclusions or pores are distributed substantially evenly throughout the casing. The gas cavities preferably have a diameter between 10 gm and 1.5 mm. The diameter is designated by the largest diameter of the respective pore or the respective gas bubble. The casing according to the invention can for example be an anti-kink grommet for the cable. This is a casing which is affixed on the cable and possibly also on the plug part in the area where the cable runs into the plug part. The anti-kink grommet supports the cable where it runs out of the plug part such that the cable is almost entirely prevented from kinking or tearing off of the plug part in this area. A casing according to the invention can, however, also be a so-called overmold for a main body of the plug part. This is a coating of this main body. The main body can be for example a housing of the plug part produced from metal or plastic. Of course, the casing can also be a combination including an anti-kink grommet and overmold. It can thus also have an area which is an anti-kink grommet and another area which is an overmold, wherein these two areas can cohere as a single part.

For the sake of completeness, it is noted that the finished casing according to the invention can, but does not have to, completely surround the plug part or its main body and/or the cable sealed over the perimeter. The casing can also be formed only on sections, in particular not peripherally sealed, on the plug part, its main body and/or the cable.

### BRIEF DESCRIPTION OF THE DRAWINGS

Additional features and details of preferred embodiments of the invention are explained with reference to the description of the figures below. In the figures:

FIG. 1 shows a side view of a casing formed according to the invention in the form of an anti-kink grommet;

FIG. 2 shows a schematic longitudinal section of FIG. 1 and hence the anti-kink grommet;

FIG. 3 shows a schematic representation of the production method according to the invention of the first exemplary embodiment by means of injection molding;

FIG. 4 shows the region A from FIG. 3;

FIG. 5 shows a second exemplary embodiment of a casing according to the invention that forms both an overmold for a main body of the plug part as well as an anti-kink grommet;

FIG. 6 shows a schematic longitudinal section of FIG. 5, and

FIG. 7 shows another schematic representation of the production method by means of injection molding of the embodiment according to FIGS. 5 and 6.

### DETAILED DESCRIPTION OF THE PREFERRED EMBODIMENTS

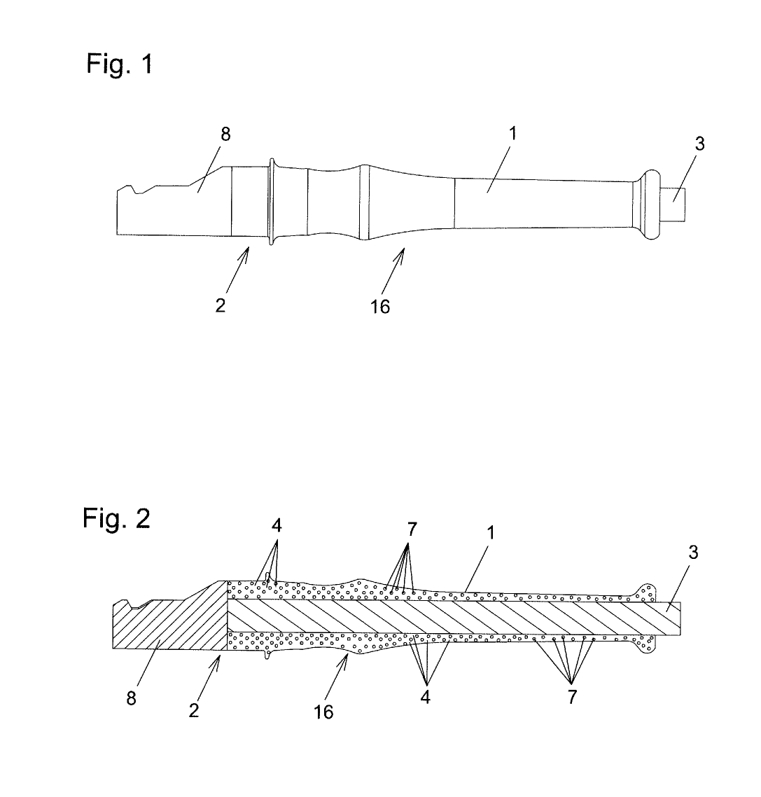

FIG. 1 shows a side view of a casing 1 according to the invention in the form of an anti-kink grommet 16 for the cable 3. Both the cable 3 as well as the main body 8 of the plug part 2 are depicted only in a highly schematic manner. This applies especially to the longitudinal section which can be seen in FIG. 2. Such an anti-kink grommet 16 with the plug part 2 attached thereupon can for example be used for a power supply cable 3 which runs into a drill, a grinder or another piece of equipment in order to protect the cable 3 from tearing off or kinking in the area where it comes out of the housing of the tool. In the depicted exemplary embodiment, the plug part 2 is provided for a detachable plug-in connection with a socket (not shown here) arranged in the piece of equipment. This of course is only one example. The anti-kink grommet 16 could just as easily be fixedly arranged on the housing of the tool.

The gas cavities 7 which are finely distributed throughout the entire casing 1 or anti-kink grommet 16 are schematically depicted in the longitudinal section according to FIG. 2. The gas cavities 7 are surrounded by a matrix formed of the thermoplastic material 4.

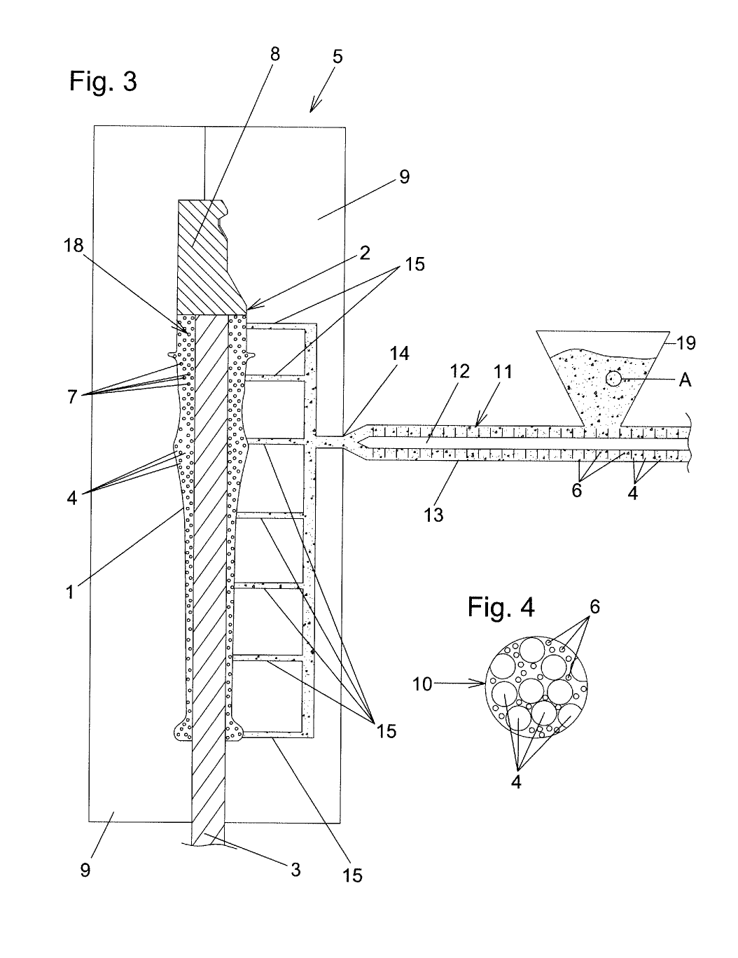

FIG. 3 is a highly schematic representation of the injection mold 5 and the injection unit 11 of an injection molding machine by which the method according to the invention can be carried out to produce the casing 1 of the plug part 2. No detailed representation of a corresponding injection molding machine will be offered since it is well known in the prior art. The injection mold 5 has two mold halves 9 as is well known. In their closed position depicted here, they enclose together a mold cavity 18 which provides the outer contour and shape of the end product, i.e. the casing 1 in this case. Before the actual injection molding process, the main body 8 and the cable 3 affixed therein are inserted into the mold cavity 18 when the injection mold 5 is open. Then the mold halves 9 are closed and pressed together with the required pressure for the injection molding process. The starting material, in this example including a mixture of thermoplastic material 4 and propellant 6, is poured into the hopper 19 of the injection unit 11. FIG. 4 portrays the region A from FIG. 3 schematically and enlarged. It can be seen that both the thermoplastic material 4 as well as the propellant 6 are present as granules in the starting material of this exemplary embodiment. In the portrayed exemplary embodiment, the injection unit 11 has a screw 12, as is well known, that is mounted rotatably about its longitudinal direction and displaceably in the longitudinal direction in the injection tube 13. The tip 14 of the injection unit 11 terminates in the injection channel 15 provided in one of the mold halves 9.

The pre-treatment of the thermoplastic material 4 in the injection unit 11 as well as the injection process itself are in principle carried out first as is well known in the prior art. It can thus be provided that, by rotating the screw 12, the material mixture including thermoplastic material 4 and propellant 6 is transported out of the storage container 19 into the injection tube 13 and transported there toward the tip 14. While being transported toward the tip 14, the thermoplastic material 4 is liquefied, possibly with the assistance of well-known heating elements (not shown here) on or in the injection tube 13. For the injection process, a corresponding amount of thermoplastic molten material 4 with a corresponding amount of propellant 6 collects in the tip of the injection tube 13. For the injection per se, the screw 12 is moved in its longitudinal direction toward the tip 14 so that the material collected in the tip 14 is injected via the injection channels 15 into the mold cavity 18 and fills it. The time when the propellant 6 mixed with the thermoplastic material 4 begins to outgas can be controlled by a corresponding temperature profile if the propellant is thermally activatable. It is for example conceivable for the outgassing process to already start in the injection tube 13 once corresponding temperatures are reached there. It is, however, just as conceivable for the propellant 6 to be first injected into the mold cavity 18 and then brought to a temperature, by heating devices arranged there and not explicitly shown in this case, which brings about the thermal activation and hence the outgassing of the propellant 6. The injection channels 15 could also be heated just as well in order to bring about a corresponding thermal activation.

In deviation from this exemplary embodiment, different and even a plurality of injection units 11 can of course also be used in methods according to the invention to inject the thermoplastic material 4 and the propellant 6, or the thermoplastic material 4 and a propellant gas, into the mold cavity. In particular, when injecting gas or propellant gas instead of propellant 6, a separate injection unit 11 can also be provided for the gas or propellant gas in order to introduce the gas or propellant gas into the mold cavity 18. It would be just as readily conceivable to first add the gas or propellant gas to the already melted thermoplastic material 4 in the region of the tip 14. A corresponding injection of propellant 6 at this location would also be conceivable.

Instead of the well-known screw 12 realized here, a simple longitudinally displaceable piston could also be provided in the injection tube 13 for the injection process. All of the suitable injection methods and injection machines known in the prior art can be used in a correspondingly adapted manner for the method. The variant shown in FIG. 3 is only an example.

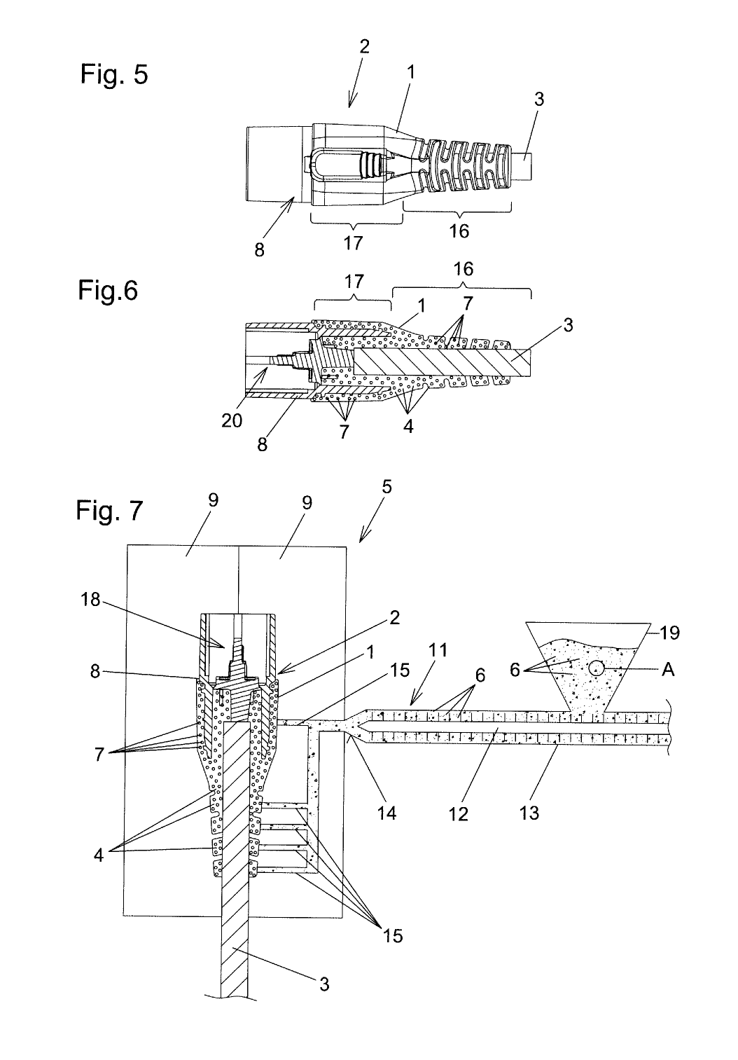

FIGS. 5 to 7 serve to illustrate a second example according to the invention of a casing 1 and its production via injection molding. The plug part 2 depicted in a plan view in FIG. 5 and in a longitudinal section in FIG. 6 is a so-called cable plug where a cable 3 is guided into a main body 8 or a housing of the plug part 2. Such plug parts 2 can be used both for transmitting signals as well as energy. They can enable optical and/or electrical plug-in connections by being plugged into at least one other corresponding plug part (not shown here). This second or additional plug part can also be a cable plug or a device socket. The plug contacts 20 in the main body 8 which serve to transmit electrical and/or optical signals and/or energy are depicted only highly schematized in this context and, as is known in the prior art, can be realized in a wide variety of designs.

In this second exemplary embodiment, the casing 1 comprises both an area that forms an anti-kink grommet 16 as well as an area that forms an overmold 17 over the main body 8 or the housing of the plug part 2. These two areas, i.e. the overmold 17 and the anti-kink grommet 16, are injection molded together in this exemplary embodiment and are therefore realized as a single part. This can also be easily seen in the longitudinal section according to FIG. 16. The gas cavities 7 are schematically portrayed in FIG. 16 and are arranged in the thermoplastic material 4 forming the matrix finely distributed throughout the entire casing 1. Analogous to FIG. 3, FIG. 7 also shows schematized components of an injection molding machine to illustrate the method according to the invention. For its explanation as well as an explanation of the injection molding process and the relevant possible alternatives, reference is made to the description of FIG. 3. All that was stated in that context is analogously applicable in this context for producing the casing 1 by means of injection molding. Furthermore, section A from FIG. 7 corresponds to FIG. 4, i.e., the mixture 10 depicted therein including the granular thermoplastic material 4 and the granular propellant 6 mixed therewith.

### LEGEND OF REFERENCE NUMBERS

1 Casing

2 Plug part

3 Cable

4 Thermoplastic material

5 Injection mold

6 Propellant

7 Gas cavity

8 Main body

9 Mold half

10 Mixture

11 Injection unit

12 Screw

13 Injection tube

14 Tip

15 Injection channel

16 Anti-kink grommet

17 Overmold

18 Mold cavity

19 Storage container

20 Plug contact

1. A method for producing a casing of a plug part for at least one of an electrical plug-in connection, an optical plug-in connection, or a cable, the method comprising injection molding the casing from a thermoplastic material in an injection mold, and injecting at least one outgassing propellant or at least one gas or both into the injection mold in addition to the thermoplastic material, and forming gas cavities in the casing.

2. The method according to claim 1, further comprising thermally activating the at least one outgassing propellant to trigger an outgassing process.

3. The method of claim 2, wherein the at least one outgassing propellant is thermally activated in the injection mold.

4. The method according to claim 1, further comprising adding the at least one outgassing propellant to the thermoplastic material before injection, and injecting a mixture including the thermoplastic material and the at least one outgassing propellant produced in this manner into the injection mold.

5. The method according to claim 1, further comprising overmolding the casing onto a main body of the plug part or onto the cable or both.

6. The method according to claim 1, further comprising first producing the casing in the injection mold via injection molding and then attaching the casing to or on the main body of the plug part or the cable or both.

7. The method according to claim 1, wherein the at least one outgassing propellant is co-injected into the injection mold at a portion of 0.5% to 5% with reference to a state before outgassing, of an overall mass of the thermoplastic material and the at least one outgassing propellant.

8. The method according to claim 1, wherein the at least one outgassing propellant is co-injected into the injection mold at a portion of 1.5% to 2.5% with reference to a state before outgassing, of an overall mass of the thermoplastic material and the at least one outgassing propellant.

9. The method according to claim 1, wherein an injection pressure lies within a range between 5 bar and 40 bar.

10. The method according to claim 1, wherein an injection temperature lies within a range between 180° C. and 240° C.

11. A casing of a plug part for at least one of an electrical plug-in connection, an optical plug-in connection, or a cable, comprising a thermoplastic material having gas cavities therein.

12. The casing according to claim 11, wherein a porosity of the casing caused by the gas cavities lies within a range between 5% and 40% by volume.

13. The casing according to claim 11, wherein the gas cavities are formed as a plurality of gas bubbles distributed throughout the casing.

14. The casing according to claim 11, wherein the gas cavities have a diameter between 10 μm and 1.5 mm.

15. The casing according to claim 11, wherein the casing is an anti-kink grommet for the cable.

16. The casing according to claim 11, wherein the casing is an overmold for a main body of the plug part.

17. A casing of a plug part for at least one of an electrical plug-in connection, an optical plug-in connection, or a cable, comprising a thermoplastic material having gas cavities therein that form the casing produced by the method according to claim 1.
